(19) United States
(12) Patent Application Publication
(10) Pub. No.: US 2025/0004934 A1
(43) Pub. Date: Jan. 2, 2025

(54) METHOD FOR TESTING A COMPUTER PROGRAM

(71) Applicant: Robert Bosch GmbH, Stuttgart (DE)

(72) Inventors: Christopher Huth, Heilbronn (DE); Max Camillo Eisele, Ludwigsburg (DE)

(21) Appl. No.: 18/750,128

(22) Filed: Jun. 21, 2024

(30) Foreign Application Priority Data
Jun. 30, 2023 (DE) 10 2023 206 221.6

(51) Int. Cl. G06F 11/36; G06F 11/30

(52) U.S. Cl. CPC G06F 11/3688; G06F 11/3037; G06F 11/3636; G06F 11/3696

(57) ABSTRACT

A method for testing a computer program. The method includes setting one or more breakpoints on one or more memory deallocation instructions in the computer program; executing the computer program; and, when one of the set breakpoints is triggered, setting a pointer that the memory deallocation instruction obtains as a specification of the memory area to be deallocated, to a value that triggers an exception when the pointer is subsequently used in the computer program.

### CROSS REFERENCE

The present application claims the benefit under 35 U.S.C. § 119 of German Patent Application No. DE 10 2023 206 221.6 filed on Jun. 30, 2023, which is expressly incorporated herein by reference in its entirety.

### FIELD

The present disclosure relates to methods for testing a computer program.

### BACKGROUND INFORMATION

Testing is an essential component of the development of software applications and, if errors are found, so is appropriate error correction. In particular, errors that lead to failure of an application should be identified and corrected. An important aspect is testing to ensure that important memory areas are not accessed unintentionally (or by an attacker), i.e., testing with memory monitoring, as carried out by a so-called (memory) sanitizer. Compiling and testing software on common desktop hardware and server hardware, e.g., x86, with the aid of various sanitizers is a measure against which errors, such as the heartbleed bug, which had previously remained undetected for a long time, can be discovered.

Comprehensive testing that also includes such memory monitoring is particularly important for computer programs on embedded systems, such as control devices for a vehicle, which are often relevant to safety. However, sanitizers that are used for desktop hardware and server hardware cannot be used or can only be used poorly for such systems because embedded systems typically have limited resources and such sanitizers require significant resources and thus cannot be used or can even influence the execution of the computer program such that an error is produced in the first place or that an error remains undiscovered.

Methods for testing computer programs that make memory monitoring possible and are suitable for embedded systems are therefore desirable.

### SUMMARY

According to various example embodiments of the present invention, a method for (automatically) testing a computer program is provided, comprising setting one or more breakpoints on one or more memory deallocation instructions in the computer program; executing the computer program; and, when one of the set breakpoints is triggered, setting a pointer that the memory deallocation instruction obtains as a specification of the memory area to be deallocated, to a value (e.g., null) that triggers an exception when the pointer is subsequently used in the computer program.

This can be carried out for any or at least a plurality of memory deallocation instructions occurring in the computer program (e.g., depending on how many breakpoints are available).

The above-described method makes testing with detection of dangling pointers on an embedded system with the aid of a debugger possible. This is particularly suitable for testing with fuzzing since fuzzing can also be implemented in a debugger-controlled manner and can in this way be used effectively for embedded systems.

For example, in the context of a fuzzing, the computer program can be marked as erroneous by triggering an exception since its execution causes an exception (and thus a termination or crash), whereupon the fuzzer displays an error. For example, a warning could also be output on the stderr stream or the debugger could be monitored on the host side (i.e., on the test system that is testing the computer program on an executing system by means of a debugger).

Sanitizers can be implemented by means of code instrumentation. However, this either requires the source code to be available or requires instruction-set-specific instrumentation on the basis of the binary file (binary instrumentation), which is very vulnerable. Alternative emulator-based instrumentation is also very platform-specific, and each embedded platform requires its own emulator. The above-described method makes testing with a debugger-controlled sanitizer possible and does not require instrumentation or emulation and can therefore be used in many cases.

Various embodiment examples of the present invention are specified below.

Embodiment example 1 is a method for testing a computer program as described above.

Embodiment example 2 is the method according to embodiment example 1, comprising ascertaining to which values the system on which the computer program is executed responds with an exception; and setting the value to which the pointer is set, to one of the ascertained values.

The method can thus be used for various executing systems.

Embodiment example 3 is the method according to embodiment example 1 to 2, comprising carrying out a plurality of test runs (e.g., fuzzing test runs, i.e., fuzzing iterations); and setting breakpoints on memory deallocation instructions that differ from test run to test run.

It is thus possible to cover a large number of memory deallocation instructions.

Embodiment example 4 is the method according to one of embodiment examples 1 to 3, comprising executing the computer program on an embedded system; and carrying out the setting of the breakpoints and the setting of the pointer that the memory deallocation instruction obtains as a specification of the memory area to be deallocated, to a value that triggers an exception when the pointer is subsequently used in the computer program, by means of a test system connected to the embedded system (via a debugging interface).

According to various embodiments, testing of a computer program for an embedded system, including memory monitoring, is in particular made possible on the embedded system itself.

Embodiment example 5 is a method according to one of embodiment examples 1 to 4, comprising, when one of the set breakpoints is triggered, checking whether a (local) variable (in the particular stack frame or also in a register) contains an address of a memory cell of the memory area to be deallocated, and, where appropriate, setting the variable to the or another value that triggers an exception when the pointer is subsequently used in the computer program.

It can thus, for example, be prevented that pointers calculated from the original pointer become dangling as a result of the deallocation.

Embodiment example 6 is the method according to one of embodiment examples 1 to 5, wherein the computer program is a control program for a robotic device and the robotic device is controlled with the computer program depending on a result of the test of the computer program.

Embodiment example 7 is a test arrangement configured to carry out a method according to one of embodiment examples 1 to 6.

Embodiment example 8 is a computer program comprising instructions that, when executed by a processor, cause the processor to carry out a method according to one of embodiment examples 1 to 6.

Embodiment example 9 is a computer-readable medium which stores instructions that, when executed by a processor, cause the processor to carry out a method according to one of embodiment examples 1 to 6.

In the figures, similar reference signs generally refer to the same parts throughout the different views. The figures are not necessarily to scale, emphasis being instead generally placed on representing the principles of the present invention. In the following description, various aspects are described with reference to the figures.

### BRIEF DESCRIPTION OF THE DRAWINGS

FIG. 1 shows a computer for developing and/or testing software applications, according to an example embodiment of the present invention.

FIG. 2 shows a flowchart illustrating a method for testing a computer program according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure in order to form new aspects.

Various examples are described in more detail below.

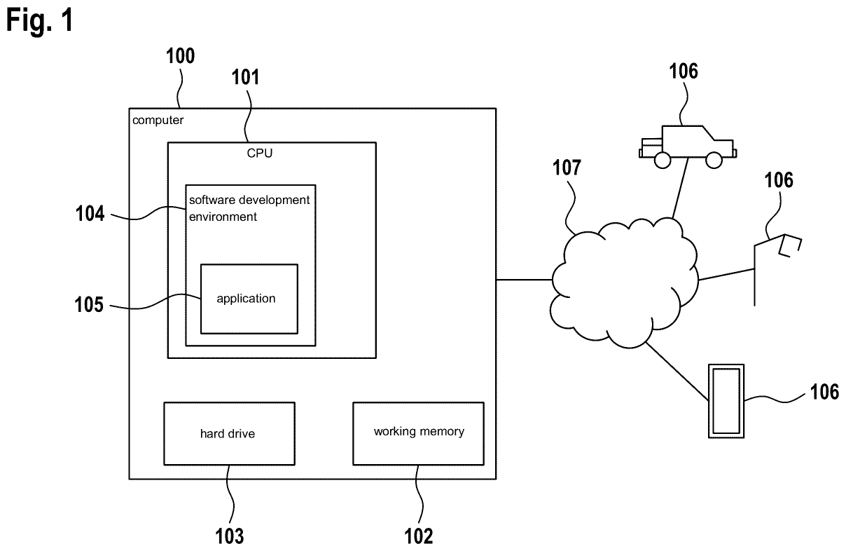

FIG. 1 shows a computer 100 for developing and/or testing software applications.

The computer 100 comprises a CPU (central processing unit) 101 and a working memory (RAM) 102. The working memory 102 is used to load program code, e.g., from a hard drive 103, and the CPU 101 executes the program code.

The present example assumes that a user intends to use the computer 100 to develop and/or test a software application.

To this end, the user executes a software development environment 104 on the CPU 101.

The software development environment 104 makes it possible for the user to develop and test an application 105 for various devices 106, i.e., target hardware, such as embedded systems for controlling robotic devices, including robot arms and autonomous vehicles, or also for mobile (communication) devices. To this end, the CPU 101 can execute an emulator as part of the software development environment 104 in order to simulate the behavior of the respective device 106 for which an application is being or has been developed. If it is used only to test software from another source, the software development environment 104 can also be considered or designed as a software test environment.

The user can distribute the finished application to corresponding devices 106 via a communication network 107. Instead of a communication network 107, this can also be done in other ways, for example by means of a USB stick.

Before this happens, however, the user should test the application 105 in order to avoid distributing an improperly functioning application to the devices 106.

One test method is so-called fuzzing. Fuzzing or fuzz testing is an automated software testing method in which invalid, unexpected, or random data are fed as inputs to a computer program to be tested. The program is then monitored for exceptions such as crashes, missing failed integrated code assertions or potential memory leaks.

Fuzzers (i.e., test programs that use fuzzing) are typically used to test programs that process structured inputs. This structure is, for example, specified in a file format or a file format or protocol and distinguishes between valid and invalid inputs. An effective fuzzer produces semi-valid inputs that are “valid enough” not to be directly rejected by the input parser of the program to be tested, but are “invalid enough” to reveal unexpected behaviors and limit cases that are not being handled properly in the program to be tested.

The following describes terminology used in the context of fuzzing:
Fuzzing or fuzz testing is the automated testing process of sending randomly generated inputs to a target program (program to be tested) and observing its response.
A fuzzer or fuzzing engine is a program that automatically generates inputs. It is therefore not linked to the software to be tested, and no instrumentation is carried out. However, it has the ability to instrument code, generate test cases, and execute programs to be tested. Conventional examples are afl and libfuzzer.
A fuzz target is a software program or a function that is to be tested by means of fuzzing. A key feature of a fuzz target should be that it accepts potentially untrustworthy inputs generated by the fuzzer during the fuzzing process.
A fuzz test is the combined version of a fuzzer and a fuzz target. A fuzz target can then be instrumented code in which a fuzzer is linked to its inputs (i.e., provides said inputs). A fuzz test is executable. A fuzzer can also start, observe, and stop a plurality of fuzz tests (typically hundreds or thousands per second), each with a slightly different input generated by the fuzzer.
A test case is a specific input and a specific test run from a fuzz test. Runs that are interesting for reproducibility (finding new code paths or crashes) are typically stored. A specific test case with the corresponding input can in this way also be executed on a fuzz target that is not connected to a fuzzer, e.g., the release version of a program.
Coverage-guided fuzzing uses code coverage information as feedback during fuzzing, in order to detect whether an input has caused the execution of new code paths or blocks.
Generation-based fuzzing uses previous knowledge about the target program (fuzz target) to create test inputs. An example of such prior knowledge is grammar that corresponds to the input specification of the fuzz target, i.e., the input grammar of the fuzz target (i.e., of the program to be tested).
Static instrumentation is the insertion of instructions into a program (to be tested) in order to obtain feedback on the execution. It is generally realized by the compiler and can, for example, indicate the code blocks reached during execution.
Dynamic instrumentation is the control of the execution of a program (to be tested) during runtime, in order to generate feedback from the execution. It is usually realized by operating system functionalities or by the use of emulators.
A debugger is a device or program that can control a target device or target program and can provide functions, e.g., for retrieving register values or memory values and for pausing and executing the target program in individual steps.
A breakpoint is set via a debugger on an instruction of the target program or device in order to stop execution when said breakpoint is reached and to inform the controlling process in this respect.
A (data) watchpoint is set via a debugger on a memory address of a target program or target device in order to stop execution if the memory address is accessed, and to inform the controlling process in this respect by triggering an interrupt.

Embedded systems generally comprise a microcontroller that processes inputs and responds with outputs in order to accomplish a particular task. Even though microcontrollers use the same memory model and are programmed with the same programming languages as ordinary user programs, their programs are much more difficult to test. In order to make debugging possible, microcontrollers generally provide the ability to interrupt the program with breakpoints, run through the program's instructions in individual steps, and set watchpoints on memory addresses. Watchpoints trigger an interrupt when the corresponding memory areas are accessed. Hardware breakpoints and watchpoints are typically implemented as physical registers in the debug unit of a microcontroller; their number is therefore limited and depends on the respective system. The maximum number for a typical microcontroller is four breakpoints and two data watchpoints, for example. Watchpoints can usually distinguish between read access and write access.

Breakpoints and watchpoints can in particular be used to realize debugger-controlled fuzzing, so that no instrumentation is required.

Fuzzing, also debugger-controlled fuzzing, is very efficient at finding errors that trigger observable behavior, such as a crash or restart. However, entire classes of errors cannot be observed, since the program fails silently when these occur. One example is the heartbleed bug. The essence of the heartbleed bug was that it only reads beyond the boundary of an array, whereas a write operation would have caused an easily observable segmentation error.

The heartbleed bug was only found with the aid of the Address Sanitizer (Asan). Asan inserts additional instructions, metadata, and checks during the compilation of a program, in order to prevent memory corruption errors. When such sanitizer instructions are available in a program, more errors can be found when debugging the program than without a sanitizer. In particular, automated tests, such as fuzzing, shine when a sanitizer is provided in the program to be tested (i.e., in the fuzz target) in order to reveal additional errors.

For embedded systems such as a data processing device with an ARM architecture, such sanitizers are not as easy to use as for standard platforms, such as x86 platforms. This is because of several reasons:
An embedded system is too resource-constrained to implement a sanitizer. For example, Asan requires twice the memory, Msan (MemorySanitizer) requires 2.5 times the resources, and UBSan (UndefinedBehaviorSanitizer) even requires three times the working memory of the program.
Sanitizers increase the size of the compiled binary file. In the automotive industry, the size of such binary files is generally close to the available flash memory of the target hardware. Additional instrumentation of a sanitizer would therefore not fit into the flash memory.
Due to the additional instrumentation of sanitizers and the collection and tracking of metadata, the use of a sanitizer results in a slower runtime of a binary program on the respective hardware. Embedded systems are highly dependent on asynchronous events, such as interrupts, and sanitizers can therefore lead to time-based false positive errors, i.e., a sanitizer can introduce new errors during runtime.
Embedded systems generally do not have a user interface for displaying runtime errors. On x86 systems, for example, a segmentation error is forwarded to STDERR so that the user sees the crash. Embedded systems, on the other hand, fail silently, i.e., without the user noticing, and restart after such a crash.

According to various embodiments, an approach is therefore provided that makes the use of memory monitoring (i.e., a sanitizer functionality) for an embedded system possible, in particular such that the memory monitoring can be used for debugger-controlled fuzzing. The memory monitoring itself is made possible with the aid of a debugger (or the debugger used for fuzzing).

In debugger-based fuzzing, interactions between the system carrying out the test (and, for example, corresponding to the computer 100) and the target system (target hardware, e.g., an embedded system, for example a target device 106) take place via a debug connection (i.e., debug interface) that is provided, for example, by a dedicated debugger hardware device. The test input data are transmitted in the form of an input vector, for example via WiFi or a CAN bus (depending on the type of the target device 106), to the target system 106, i.e., the communication network 107 in this testing is such a debug connection (when the tested software is distributed, the communication network can then be any other communication network). The system that carries out the test, hereinafter also referred to as the test system 100, controls the execution of the target program (i.e., of the program to be tested) in the target system via the debug connection, i.e., starts the execution and resumes the execution after an interrupt (in particular an interrupt triggered by a data watchpoint).

A debugger-controlled sanitizer requires no instrumentation or emulation but only a debug interface to the target system (e.g., an embedded system on which the software is being executed) with the ability to set breakpoints and watchpoints. These types of debug interfaces and debug capabilities are generic and widely available, which leads to a broad and easy applicability of the approach described below. In addition, the memory of the target system is loaded only slightly, for example for metadata, since most or all sanitizer-related information is collected and stored on the host site of the debugger (i.e., in the testing system 100) so that the embedded system can also be tested in its final version (as sold, for example). The size of the compiled binary file of the target program is not increased, since it can be used for testing as it is intended for use on the target system 106.

A debugger stops the target system when a breakpoint is reached. Therefore, the approach described below only leads to time-based false alarms in rare cases. These false alarms can also be ruled out by other test techniques, e.g., by subsequently validating a found error on the target system. The use of a debugger also provides good insight into the internals of a target system.

The approach described below serves to detect dangling pointers with a debugger. A dangling pointer is a pointer that points to invalid (e.g., no longer valid) data. An example in this respect is the following program code.

```
#include <stdlib.h>
void func( )
{
  char *dp = malloc(A_CONST);
  /* ... */
  free(dp); /* dp is now a dangling pointer */
  /* ... */
}
```

The pointer dp becomes dangling when the memory area to which it points is deallocated. After calling the memory deallocation instruction (free in this example), any reference by means of the pointer can thus lead to unwanted behavior, in particular a data leak.

The problem of a dangling pointer can be avoided by setting the pointer to null after the memory deallocation instruction:

```
#include <stdlib.h>
void func( )
{
  char *dp = malloc(A_CONST);
  /* ... */
  free(dp); /* dp is now a dangling pointer */
  dp = NULL; /* dp is now no longer dangling */
  /* ... */
}
```

However, this must be programmed into the computer program by the programmer.

According to various embodiments, it is therefore provided to detect (by means of a debugger that does not need to run on the executing system) such deficiencies (i.e., program code, specifically a memory deallocation instruction leading to a dangling pointer, for example on the basis of the binary file of the computer program). In the event of such a detection, the pointer that specifies the memory area to be deallocated by the memory deallocation instruction is set to null (or also another value that triggers or causes an exception). Another parameter may also be set to such a value, e.g., a variable containing an address that also points to or into the memory area to be deallocated (e.g., a pointer derived from the original pointer).

As described above, it is assumed that the test system 106 is connected by means of a debug connection to the executing (e.g., embedded) system 106 and tests the execution of the computer program to be tested on said system by means of a debugger.

For example, the test system 100 carries out the following:
Setting breakpoints on a memory deallocation instruction, 1. e.g., free or a function that calls free. In order to select those memory deallocation instructions of the memory deallocation instructions present in the computer program on which breakpoints are set, various strategies can be used (e.g., randomly or according to a list, which is processed in a plurality of fuzzing iterations, i.e., such that each memory deallocation instruction has been provided with a breakpoint, for example in at least one fuzzing iteration, i.e., in order to test all memory deallocation instructions, the same test case can be carried out for different placements of breakpoints if there are not enough breakpoints available for all memory deallocation instructions).
2. When executing the computer program, when one of the set breakpoints is triggered, i.e., a memory deallocation instruction is executed (e.g., free is called), the pointer (or also a variable derived from the pointer) is set to a value that triggers an exception (such as null or another particular bit pattern to which the executing system responds with an exception). As a result, when the pointer is again used for referencing, an exception is triggered, for example a null pointer exception when the pointer has been overwritten with null, so that its use after the memory deallocation instruction is visible.

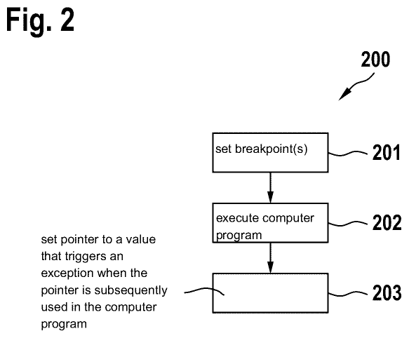

In summary, according to various embodiments, a method as shown in FIG. 2 is provided.

FIG. 2 shows a flowchart 200 illustrating a method for testing a computer program according to one embodiment.

In 201, one or more breakpoints are set on one or more memory deallocation instructions in the computer program.

In 202, the computer program is executed, wherein, in 203, when one of the set breakpoints is triggered, the pointer that the memory deallocation instruction obtains as a specification of the memory area to be deallocated is set to a value (e.g., null) that triggers an exception when the pointer is subsequently used in the computer program.

A response to the exception may then, for example, be displaying that the computer program contains an error.

The method of FIG. 2 can be carried out by one or more computers comprising one or more data processing units. The term “data processing unit” can be understood to mean any type of entity that makes the processing of data or signals possible. The data or signals can, for example, be processed according to at least one (i.e., one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuitry. One or more of the method steps described in detail here can be performed (e.g., implemented) by a data processing unit by means of one or more specific functions carried out by the data processing unit.

The approach of FIG. 2 is used to test a program, for example control software for a robotic device. The term “robotic device” can be understood as relating to any technical system, such as a computer-controlled machine, a vehicle, a household appliance, an electric tool, a manufacturing machine, a personal assistant, or an access control system. The control software can also be used for data processing systems such as a navigation device.

The method of FIG. 2 is carried out by a test arrangement (e.g., the computer 100 and the target device 106 of FIG. 1), for example.

Although specific embodiments have been illustrated and described here, a person skilled in the art in the field will recognize that the specific embodiments shown and described may be exchanged for a variety of alternative and/or equivalent implementations without departing from the scope of protection of the present invention. This application is intended to cover any modifications or variations of the specific embodiments discussed here.

What is claimed is:

1. A method for testing a computer program, comprising the following steps:
setting one or more breakpoints on one or more memory deallocation instructions in the computer program;
executing the computer program; and
setting, when one of the set breakpoints is triggered, a pointer that the memory deallocation instruction obtains as a specification of a memory area to be deallocated, to a value that triggers an exception when the pointer is subsequently used in the computer program.

2. The method according to claim 1, further comprising:
ascertaining to which values the system on which the computer program is executed responds with an exception; and
setting the value to which the pointer is set to one of the ascertained values.

3. The method according to claim 1, further comprising:
carrying out a plurality of test runs and setting breakpoints on memory deallocation instructions that differ from test run to test run.

4. The method according to claim 1, further comprising:
executing the computer program on an embedded system; and
carrying out the setting of the breakpoints and the setting of the pointer that the memory deallocation instruction obtains as the specification of the memory area to be deallocated, to the value that triggers an exception when the pointer is subsequently used in the computer program, using a test system connected to the embedded system.

5. The method according to claim 1, further comprising:
when one of the set breakpoints is triggered, checking whether a variable contains an address of a memory cell of the memory area to be deallocated, and, if so, setting the variable to the value or another value that triggers an exception when the pointer is subsequently used in the computer program.

6. The method according to claim 1, wherein the computer program is a control program for a robotic device and the robotic device is controlled with the computer program depending on a result of the test of the computer program.

7. A test arrangement configured to test a computer program, the test arrangement configured to:
set one or more breakpoints on one or more memory deallocation instructions in the computer program;
execute the computer program; and
set, when one of the set breakpoints is triggered, a pointer that the memory deallocation instruction obtains as a specification of a memory area to be deallocated, to a value that triggers an exception when the pointer is subsequently used in the computer program.

8. A non-transitory computer-readable medium on which is stored instructions for testing a computer program, the instructions, when executed by a processor, causing the processor to perform the following steps:
setting one or more breakpoints on one or more memory deallocation instructions in the computer program;
executing the computer program; and
setting, when one of the set breakpoints is triggered, a pointer that the memory deallocation instruction obtains as a specification of a memory area to be deallocated, to a value that triggers an exception when the pointer is subsequently used in the computer program.
